(19) United States
(12) Patent Application Publication
(10) Pub. No.: US 2002/0199117 A1
(43) Pub. Date: Dec. 26, 2002

(54) System for distributing application software

(75) Inventor: Kenichi Nagaya, Shizuoka (JP)

Correspondence Address: DARBY & DARBY P.C., 805 Third Avenue, New York, NY, 10022, US

(73) Assignee: NETMAN CORPORATION

(21) Appl. No.: 09/996,331

(22) Filed: Nov. 28, 2001

(30) Foreign Application Priority Data
Jun. 26, 2001 (JP) 2001-192358

(51) Int. Cl. H04L 9/00

(52) U.S. Cl. 713/201; 705/59; 713/150

(57) ABSTRACT

A system for distributing application software includes an Internet server and a control server for setting firewall software, which has an application distribution unit for storing downloadable application software purchased by a user of the Internet server, wherein the firewall software and software for downloading the application software from the control server and installing it to the Internet server are pre-installed to the Internet server.

### BACKGROUND OF THE INVENTION

1. Field of the Invention

The present invention relates to a system for distributing application software in which a user can install application software to an Internet server having a firewall.

2. Description of the Related Art

Conventionally, due to the regulation of a firewall set to an Internet server, a user cannot necessarily safely download application software obtained via a network to the Internet server while positively assuring the security.

When the application software is downloaded to the Internet server, inconveniently, the user needs to additionally install the application software.

### SUMMARY OF THE INVENTION

Accordingly, to solve the above-mentioned problems, it is one object of the present invention to provide a system for distributing application software, in which the application software can safely be downloaded to an Internet server and promptly be used while assuring the security without the regulation of a firewall.

It is another object of the present invention to provide a system for distributing application software, in which application software can be provided to a user of a specified Internet server without the affection of a firewall.

It is further another object of the present invention to a system for distributing application software, in which information on the using trend can be managed every user and application based on application software selected by a user of an Internet server.

According to an aspect of the present invention, there is provided a system for distributing application software, comprising: an Internet server; and a control server for setting firewall software, comprising an application distribution unit which stores downloadable application software purchased by a user of the Internet server, wherein the firewall software and software for downloading the application software from the control server and installing it to the Internet server are pre-installed to the Internet server.

Preferably, in the system for distributing the application software, under the permission of an administrator of the control server, a third party can supply the application software to the application distribution unit in the control server.

Preferably, in the system for distributing the application software, the Internet server can be specified and authenticated to download the application software.

Preferably, in the system for distributing the application software, the application distribution unit can distribute not only a program for the application software but also various data such as a moving picture, a still picture, graphic data, music, and characters.

Preferably, in the system for distributing the application software, the control server may further comprise a status monitoring unit corresponding to the firewall software set to each Internet server, and a license issuing unit. The user of the specified Internet server can download and install test application-software from the application distribution unit and test it, and can request a license to the license issuing unit and purchase formal application software, and monitored information, which is transmitted by the status monitoring unit, can be transmitted to the specified Internet server.

Preferably, the system for distributing the application software may further comprise: a network payment unit which is linked to a credit/payment server, wherein the license issuing unit may issue a license when checking the payment to an account of the network payment unit.

Preferably, in the system for distributing the application software, a key of the firewall software may be set by manually inputting and recording ID plane text and password plane text determined by an administrator of the control server to the control server, the ID plane text and a signature encrypted by the ID plane text may be informed to the user of the Internet server via transmitting means via no network, such as a hard mail and the user may manually input and record them to the Internet server, and information may be transmitted between the Internet server and the control server by using the ID plane text, the signature encrypted by the password, and a document encrypted by the signature.

### BRIEF DESCRIPTION OF THE DRAWINGS

FIG. 1 is a block diagram of a system for distributing application software in the present invention;

FIG. 2 is a block diagram of the structure of a system of an Internet server;

FIG. 3 is a block diagram showing a system for distributing application software according to a first embodiment of the present invention;

FIG. 4 is a block diagram showing a system for distributing application software according to a second embodiment of the present invention;

FIG. 5 is a block diagram showing a system for distributing application software according to a third embodiment of the present invention; and

FIG. 6 is a diagram showing a procedure for interchanging a message between an Internet server and a control server.

### DESCRIPTION OF THE PREFERRED EMBODIMENTS

Hereinbelow, a description is given of a system for distributing application software according to embodiments of the present invention with reference to the drawings.

In the present invention, the application software is not limited to a program for application, and may be various data such as a moving picture, a still picture, graphic data, music, and characters.

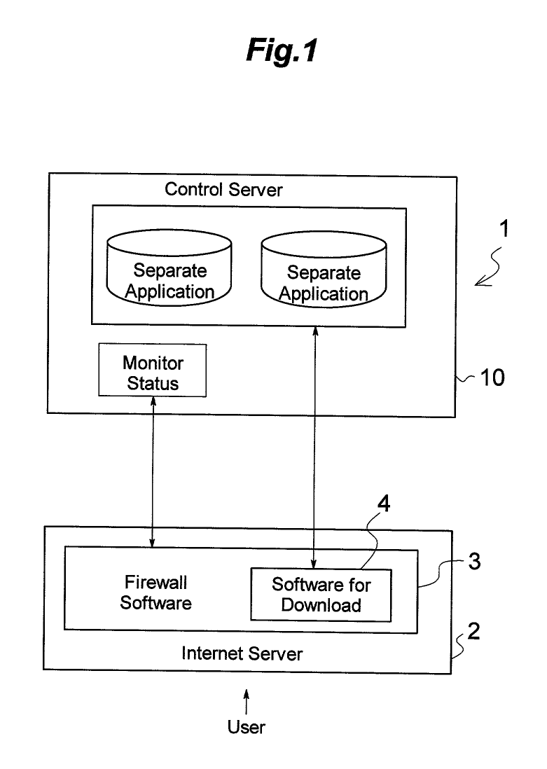

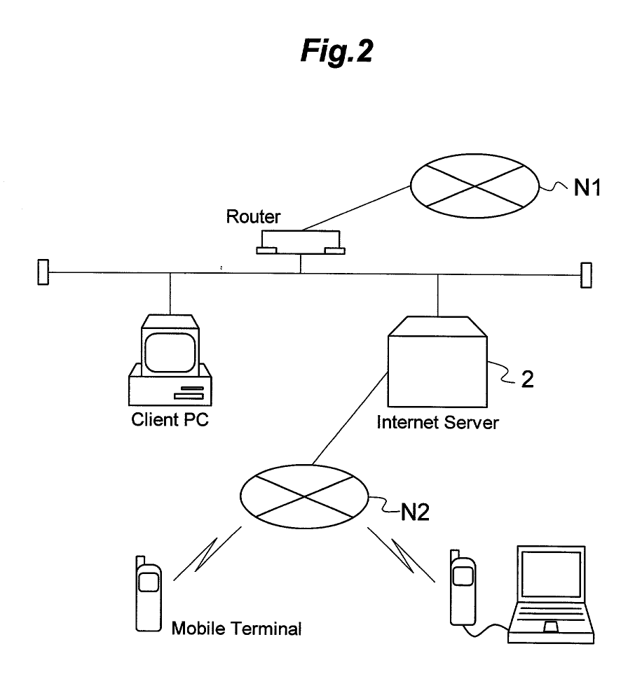

A system 1 for distributing application software shown in FIGS. 1 and 2 comprises firewall software 3 stored in an Internet server 2 and software 4 for download.

As shown in FIG. 2, the Internet server 2 is connected to a computer network (Internet) N1 via a router, and another client PC can be connected to the Internet via a LAN.

The Internet server 2 can be connected to a mobile terminal network N2 accessible to the Internet via an i-mode (registered trademark) and can be connected to the Internet by using a mobile terminal via a PDA (personal digital assistant).

The user of the Internet server 2 can set the firewall software 3 to ensure the security of the Internet.

A security function of the firewall software 3 operates based on the above setting to monitor hacker attacks to computer network communication of the Internet server 2 and the system status.

The user himself can set a function for receiving a service in that the diagnosis (monitored information) of an operating status of the Internet server 2 is sent to him via an email every day.

The firewall software 3 internally monitors the operating status of the Internet server 2, and sends the monitored information to the control server 10. The control server 10 externally monitors the operating status of the Internet server 2, diagnoses the operating statuses of the Internet server 2, which are monitored internally and externally, based on diagnostic software, sends the diagnosis (monitored information) to the user via the email.

Further, the site of the Internet server 2 stores application software for i-mode (registered trademark) of a mobile terminal as a terminal of the Internet server 2, and image data or audio data in separate application files. The user can freely download the above application software and data via the Internet server 2.

Furthermore, the site of the Internet server 2 stores application software for network, such as inventory management software, customer management software, and business support software in separate application files different from the above ones. The user can select necessary application software and freely download with charge.

The software 4 for download downloads the application software specified by the user from the control server 2 and automatically installs it to the Internet server 2.

The software 4 for download has a function for downloading the application software on the control server 2 and for automatically installing the downloaded software to the Internet server 2.

The firewall software 3 presets a process for authenticating that the application software on the control server 2, which is downloaded, is safe.

Consequently, even if the security of the firewall software 3 is set to be at a greatly high level, the application software on the control server 2 can safely be downloaded without fail.

The user can select various application software provided on the site of the control server 10 and download and install the selected application software. An administrator of the control server 10 can provide various application software oriented to the user of the Internet server 2.

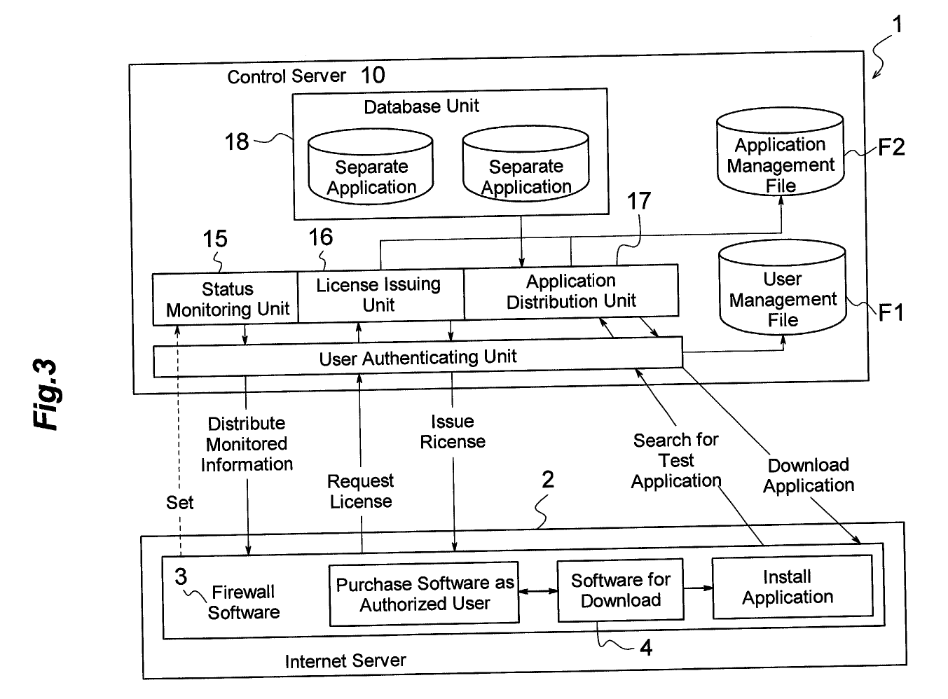

FIG. 3 is a block diagram showing a system for distributing application software according to a first embodiment of the present invention.

Referring to FIG. 3, the control server 10 comprises a status monitoring unit 15 corresponding to the firewall software 3 set every Internet server 2, a license issuing unit 16, and an application distribution unit 17. The application distribution unit 17 can call numerous application software stored in a database unit 18 connected thereto.

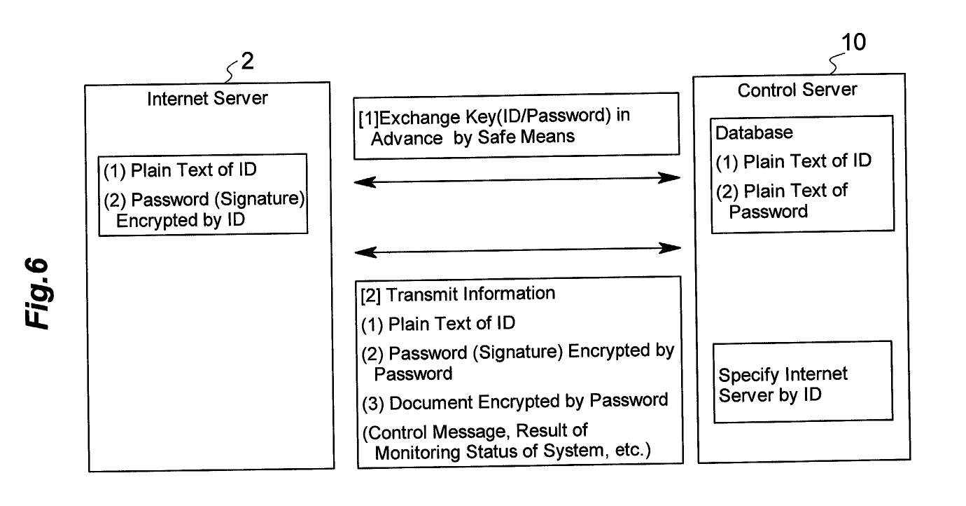

Reference numeral 12 denotes a user authenticating unit for authenticating the Internet server 2 which accesses the control server 10, which will be shown in FIG. 6.

The control server 10 has a user management file F1 for recording user information such as user's location, category of business, size, other company data, and password and an application management file F2 for recording management information on the application software and data.

First, the user who downloads the Internet server 2 and accesses the site which manages by the Internet server 2 through the Internet.

The control server 10 may manage the accessed site. If not so, the site is linked to jump to the site of the control server 10.

Keys (ID plane text and password plane text) set by the administrator of the control server 10 are manually inputted and, then, the keys are sent to the user of the Internet server 2 not via the network, e.g., via a hard mail (that is, by post) and are manually inputted to the Internet server 2. Incidentally, in the first embodiment, plane text is the base of encryption. As a consequence of the operations, the firewall software 3 is set.

The ID and the password encrypted by the ID are recorded to the Internet server 2 (refer to FIG. 6).

The diagnostic service for the Internet server 2 is set on the homepage of the Internet server 2 by the user. The diagnostic service starts by transmitting, to the control server 10, the information (internal information) monitored by the Internet server 2.

As shown in FIG. 6, the application software is downloaded and the monitored information is transmitted, that is, information is interchanged between the Internet server 2 and the control server 10 via an SMTP (Simple Mail Transfer Protocol) or the like, by using the ID plane text, a password (signature) encrypted by the password, and a document encrypted by the password.

The password plane text is recorded only to the control server 10, and the password encrypted by the ID plane text is recorded to the Internet server 2.

The Internet server 2 decrypts the password plane text based on the password encrypted by the ID plane text, forms the signature encrypted by the password plane text and the document encrypted by the password, and transmits the formed information and the ID plane text to the control server 10.

The control server 10 can specify the Internet server 2 based on the combination of the ID plane text which is obtained from the monitored information and the decrypted password text.

Since a message in the monitored information (internal information) is encrypted with an electronic signature, the Internet server 2 can be specified and the falsification can be prevented.

In response to the monitored information (internal information), the status monitoring unit 15, serving as a status monitoring engine, in the computer server 10 determines the diagnosis based on the overall monitored information (the internal and external information), and issues the diagnosis to the user and the administrator of the control server 10. According to the first embodiment, the monitored information is transmitted via the email.

In the case of distributing the application programs, similarly with the foregoing, the authentication is performed.

First, the Internet server 2 requests data of a distribution list to the application distribution unit 17 in the control server 10.

In this case, the Internet server 2 transmits information by using the ID plane text, the password (signature) encrypted by the password plane text, and the document encrypted by the signature, and is connected to the control server 10.

In the control server 10, as mentioned above, the user authenticating unit 12 specifies the Internet server 2, and transmits the data of the distribution list, including the application software and various data which are stored in the database unit 18. Since this transmission uses the ID plane text, the encrypted password (signature), etc., as mentioned above, the passage through the firewall software 3 of the Internet server 2 becomes possible.

The user who accesses the Internet server 2 selects his desired application software or data while viewing the distribution list.

When the distribution is requested, similarly, the user authenticating unit 12 in the control server 10 specifies the Internet server 2 by using the ID plane text, the signature, and the document encrypted by the password.

The application distribution unit 17, as the application distribution engine, searches for or extracts the application software or data which is requested among the database unit 18. The application software or data is downloaded to the Internet server 2 by using the ID plane text and the signature. In the case of the application software, it is further installed.

According to the first embodiment, the application software or data for the mobile terminal as the terminal of the Internet server 2 can freely be downloaded without charge.

Business software for network can be obtained with charge.

That is, the user freely downloads his desired test business software for network without charge from the application distribution unit 17.

When the user tests his desired application software and thereafter determines to purchase it, he accesses the site of the control server 10 and is licensed to purchase the formal application software from the license issuing unit 16 serving as the license issuing engine.

The license issuing unit 16 can use well-known methods such as a method for deleting the test application-software and downloading formal application-software, a method for adding necessary software to the test application-software, or a method for resetting the regulation of the test application-software by inputting keywords.

The license issuing unit 16 may have means for checking the user's payment for the purchase.

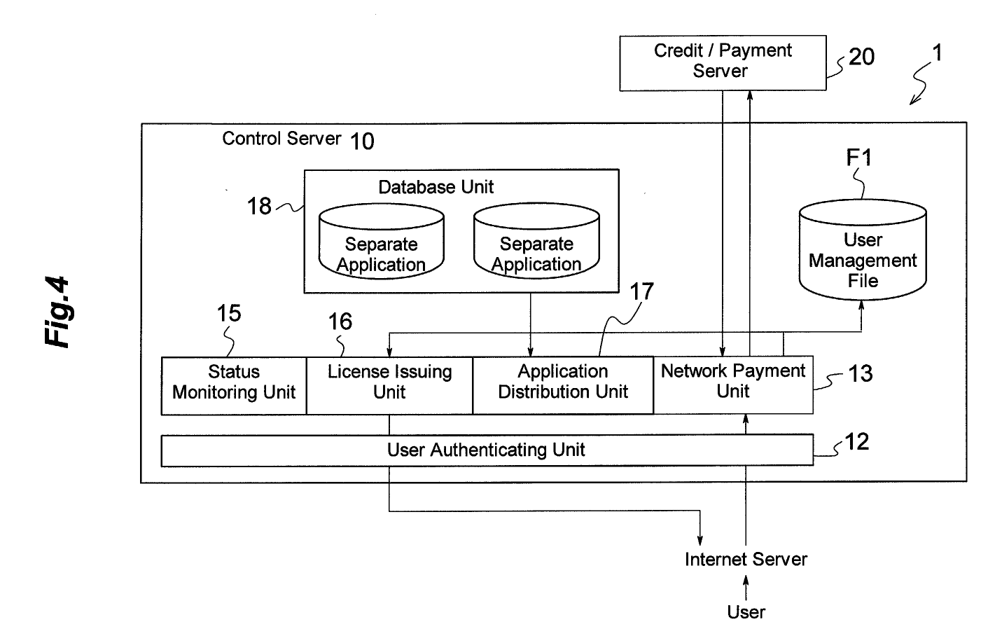

As shown in FIG. 4, according to the second embodiment, a network payment unit 13 linked to a credit/payment server 20 is provided. When the user performs the procedure for payment to the account of the network payment unit 13, payment processing is performed via the credit/payment server 20 linked. The payment processing is checked and then the license issuing unit 16 issues a license.

The desired application software is downloaded and installed to the Internet server 2 only by selecting it from the control server 10 and, thus, the user can promptly use it.

Since the application management file F2 manages the application software and data, which are downloaded by the user, the control server 10 can collect various information on the trend of the application software and the data downloaded by the user, the application software which is used only for trial and is not purchased, data of the formal application software which is purchased, etc.

It is also possible to analyze information such as the trend for using the application software and the data based on the properties of the category of business, the size, and the region by combining the user information in the user management file F1 to the information in the application management file F2.

The obtained information can be provided for developers and manufacturers of the application software and the data.

Information on the trend for using the type of the application software and the data can be analyzed every user based on the information in the application management file F2.

It is possible to use the obtained information as descriptive materials when providing application software and data which engage the interest of the user and information of various commodity.

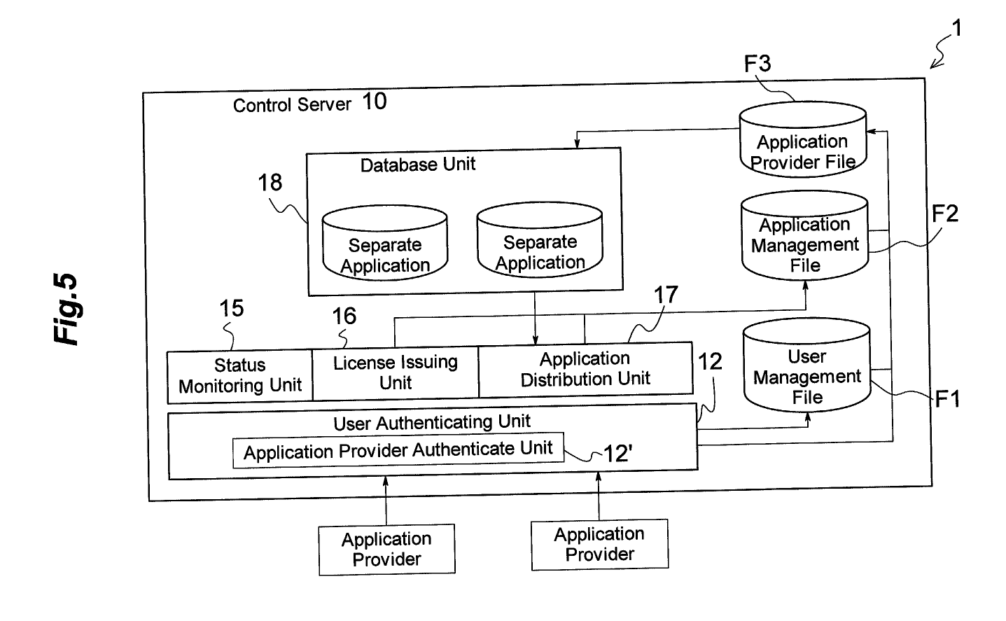

Under the permission of the administrator of the control server 10, an application provider serving as a third party can record the application software and the data, which are provided by the application distribution unit 17, to the database unit 18 (refer to FIG. 5).

The application provider is authenticated as one from the administrator of the control server 10 by an authenticating unit 12′ and is registered in an application provider management file F3. The application software and the data, which are provided by the application provider authenticated, are registered in the database unit 18 and, thus, the user can select them.

Other configurations are the same as those in the first and second embodiments, and the information can be managed by combining the user management file F1 and the application management file F2.

The analysis of the information on the application software and the data may be provided only for the registered application provider.

As mentioned above, the application software and the data can be provided for the users, irrespective of the charge.

In the present invention, the application software can safely be downloaded to the Internet server while ensuring the security without the regulation of the firewall.

Further, the Internet server downloaded through communication can be specified. Therefore, the license of the each Internet server and the application installed can be grasped.

By providing the application distribution unit for the control server which sets the firewall, the application software can be distributed via the network with user's safety. The downloaded application software can automatically be installed to the Internet server and, therefore, the user can promptly use the application software.

The application software can be provided for the user of the Internet server without the affection of firewall, and application software from other application providers can be provided once.

Further, since the user information and the information on distributing the application can be stored, the information can effectively be provided.

What is claimed is:

1. A system for distributing application software, comprising:
an Internet server; and
a control server for setting firewall software, comprising an application distribution unit which stores downloadable application software purchased by a user of said Internet server,
wherein the firewall software and software for downloading the application software from said control server and installing it to said Internet server are preinstalled to said Internet server.

2. A system according to claim 1, wherein under the permission of an administrator of said control server, a third party can supply the application software to said application distribution unit in the control server.

3. A system according to claim 1, wherein said Internet server can be specified and authenticated to download the application software.

4. A system according to claim 1, wherein said application distribution unit can distribute not only a program for the application software but also various data such as a moving picture, a still picture, graphic data, music, and characters.

5. A system according to claim 3, wherein said control server further comprises a status monitoring unit corresponding to the firewall software set to each Internet server, a license issuing unit, and an application distribution unit,
the user of the specified Internet server can download and install test application-software from said application distribution unit and test it, and said user requests a license to said license issuing unit and purchases formal application software, and
monitored information which is transmitted by said status monitoring unit can be transmitted to the specified Internet server.

6. A system according to claim 5, further comprising:
a network payment unit which is linked to a credit/payment server,
wherein said license issuing unit issues a license when checking the payment to an account of said network payment unit.

7. A system according to claim 1, wherein a key of the firewall software is set by manually inputting and recording ID plane text and password plane text determined by an administrator of said control server to said control server, said ID plane text and a signature encrypted by the ID plane text are informed to the user of the Internet server via transmitting means via no network, such as a hard mail and the user manually inputs and records them to the Internet server, and
information is transmitted between said Internet server and said control server by using the ID plane text, the signature encrypted by the password, and a document encrypted by said signature.
